(19) United States
(12) Patent Application Publication
(10) Pub. No.: US 2021/0238857 A1
(43) Pub. Date: Aug. 5, 2021

(54) HEATING SYSTEM WITH ADHESIVE CLIP

(71) Applicant: Steven S. Kuhl, Hopkins, MN (US)

(72) Inventor: Steven S. Kuhl, Hopkins, MN (US)

(21) Appl. No.: 16/983,898

(22) Filed: Aug. 3, 2020

Related U.S. Application Data
(63) Continuation-in-part of application No. 29/722,988, filed on Feb. 3, 2020.

(51) Int. Cl. E04D 13/10; H05B 1/02; F16L 3/137

(52) U.S. Cl. CPC E04D 13/103; H05B 3/56; F16L 3/137; H05B 1/023

(57) ABSTRACT

A system is provided for preventing the buildup of ice dams on a roof system of a building. The system includes a heating cable configured to generate heat, and a fastening system configured to hold the heating cable in place. The fastening system further includes at least one adhesive clip which is configured to adhere to smooth flat surfaces present on the building. The adhesive clip includes a cable cradle and a base portion with a bottom surface on which an adhesive layer is arranged.

### CROSS-REFERENCE TO RELATED APPLICATIONS

This application is a Continuation-In-Part of U.S. application Ser. No. 29/722,988, filed on Feb. 3, 2020, which is hereby incorporated by reference in its entirety.

### BACKGROUND

Heating systems have been used to prevent ice dams from forming along roof edges and gutters of buildings located in areas with freezing temperatures. Usually, in these systems, heating cables are routed along the edge of the roof in a way that they form a zig-zag triangular pattern to provide channels where water can flow. Likewise, the heating cables may be routed along the interior of a roof gutter as to provide a flow channel and keep water from freezing within the gutter. In this way, water on the roof can flow down a path so that it is able to be removed from the roof without freezing.

Securing the heating cable to the roof of a building presents several challenges. First due to the roof's high exposure to sunlight and position on the exterior of the building, the roof is often subjected to extremely high and low temperatures for extended periods of time and may be exposed to dry, wet, windy, and snowy conditions. Likewise, depending on its location, the roof may endure significant ultraviolet radiation, which also tends to have damaging effects on a variety of materials. Lastly, materials used to build roofs can be wide ranging and may include, for example, asphalt shingles, metal panels, cedar shakes, synthetic shakes, natural slate, and synthetic slate. Further complicating the process of securing the cable to the roof is the fact that it may be undesirable to nail through the roof material, as this may damage the barrier sealing the interior of the building from the outside elements. Thus, due to these environmental and structural concerns, improvements to the process of securing the heating cables to a roof are desired.

### SUMMARY

In general terms, this disclosure is directed to an adhesive clip. In one possible configuration and by non-limiting example, the clip includes a base portion and a cable cradle. Various aspects are described in this disclosure, which include, but are not limited to, the following aspects.

One aspect is a clip including a base portion and a cable cradle. The base portion is substantially flat and has a top and bottom side. The base portion further has an adhesive material arranged at its bottom side. The cable cradle is configured to receive a cable and protrudes outwardly from the base portion. The cable cradle is configured to be bendable by a user to secure the cable therein.

Another aspect is a heating system for melting ice dams on buildings. The heating system includes at least one heating cable and at least one clip. The clip includes a substantially flat base portion with an adhesive material arranged at the bottom side. The clip further includes a cable cradle configured to receive the heating cable.

A further aspect is a method of installing a heating system for melting ice dams on buildings. The method includes attaching at least one adhesive clip to a surface on a building and securing at least one heating cable to the building with the adhesive clip.

### BRIEF DESCRIPTION OF THE DRAWINGS

FIG. 1 is a perspective view of an example heating system mounted on a building.

FIG. 2 is a diagram of a portion of the example heating system of FIG. 1.

FIG. 3 is a side view of the heating portion of an example heating cable of FIG. 1.

FIG. 4 is a side view of the bus wires the first insulating coating, and resistance wires of the example heating portion of FIG. 3.

FIG. 5 is a side view of the heating portion of another example heating cable of FIG. 1.

FIG. 6 is a perspective view of an example adhesive clip of the example fastening system of FIG. 1.

FIG. 7 is a right side view of another example adhesive clip.

FIGS. 8 is a top view of the example adhesive clip of FIG. 6.

FIGS. 9 is a top view of another example adhesive clip.

FIG. 10 is a bottom view of a further example adhesive clip.

FIG. 11 is a right view of the cable cradle of the adhesive clip of FIG. 7.

FIG. 12 is a perspective view of the cable cradle of the adhesive clip of FIG. 6.

FIG. 13 is a top view of the example cable cradle of the adhesive clip of FIG. 6.

FIG. 14 is a rear view of the example cable cradle of the adhesive clip of FIG. 6.

FIG. 15 is a schematic view of an example control module of the example heating system of FIG. 2.

FIG. 16 is a perspective view of the example control module of FIG. 15.

FIG. 17 is a schematic view of another example control module of the example heating system of FIG. 2

FIG. 18 illustrates an example method of using the heating system of FIG. 1.

FIG. 19 illustrates an example method of installing the heating system of FIG. 1.

FIG. 20 illustrates an example method attaching an adhesive clip of the heating system of FIG. 1.

FIG. 21 illustrates an example method of securing the heating cable within the adhesive clip of the heating system of FIG. 1.

FIG. 22 is a side view of an example heating cable cross section secured within the cable cradle of the adhesive clip.

FIG. 23 is a perspective view of an example heating cable secured within a cable cradle of an example adhesive clip.

FIG. 24 illustrates an example method of operating the heating system of FIG. 1.

FIG. 25 illustrates an example method of uninstalling the heating system of FIG. 1.

FIG. 26 illustrates an example method of the release cable from the adhesive clip of the heating system of FIG. 1.

FIG. 27 illustrates an example method of detaching an adhesive clip of the heating system of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Snow and frozen precipitation have the potential to be problematic in regards to roof systems on heated buildings, which normally might function without issue in warmer temperatures. As snow and frozen precipitation accumulate on the roof of the building, the outer layers of frozen precipitation have the potential to insulate the inner layers of precipitation from the colder air temperatures. Meanwhile, heat from the building tends to radiate out from the roof and melt the inner insulated layers of precipitation. Thus, certain amounts of melted snow and precipitation may run down the slope of a roof towards the edge of the roof, or in some cases a gutter system, where there is less building heat. Upon reaching the edge sections of the roof, the melted precipitation tends to refreeze, due to the below freezing temperatures of the air and lack of building heat, and lodge within or around the edge of the roof or the trough of a gutter. This process is known to repeat, thus causing greater amounts of precipitation to accumulate and form a frozen mass of ice. This frozen mass will be referred to herein as an ice dam.

Ice dams can result in leaks through the roofing materials of the building, which may in turn result in damage to the ceiling, walls, insulation, or other parts of the building. Additionally, ice dams impede the functions of gutters that may be attached to the roof. Lastly, the ice dams can be dangerous, as pieces of ice have the potential to break off of the ice dam and fall on passersby below.

One way to prevent the development of ice dams is to use heating cables. In accordance with the present invention, the heating cables are mounted to the roof or gutter using clips to hold the heating cable in place. After attaching the clips to sections of the roof or gutter, the heating cable is able to be routed around the clips so that liquid precipitation within these areas is heated and diverted from the roof or gutter prior to freezing.

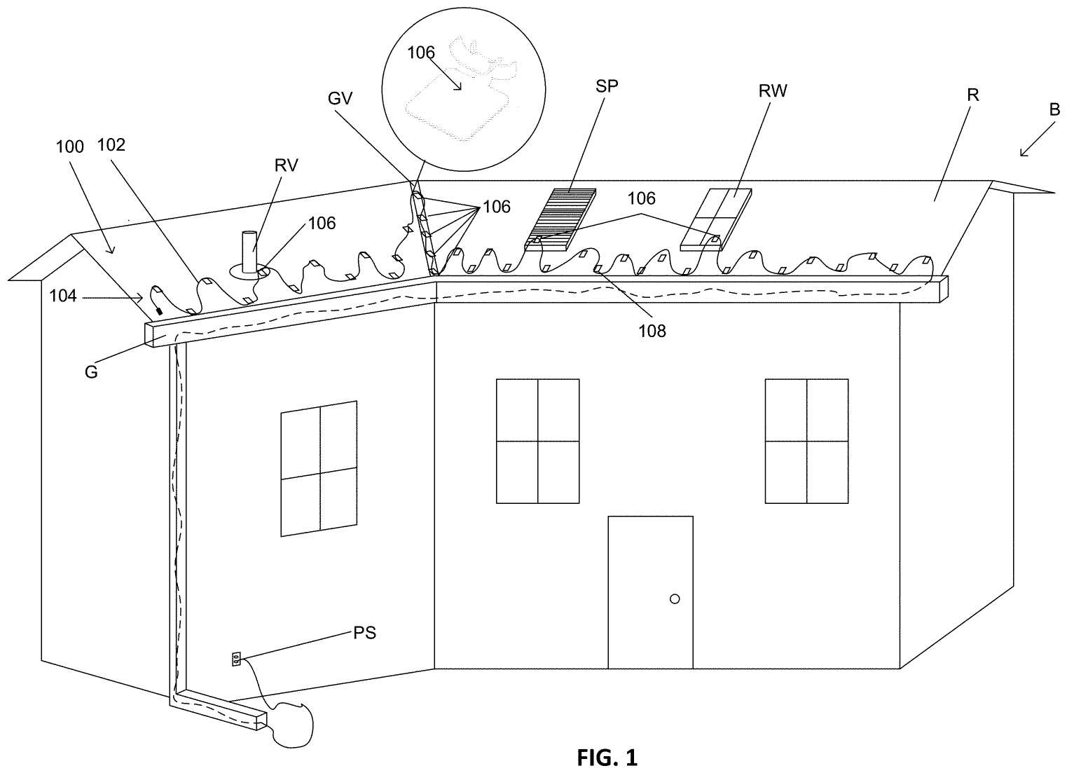

FIG. 1 is a perspective view of an example heating system 100, mounted on a building B. In this example, the building B includes a roof R, and one or more power sources PS, gutters G, gutter valleys GV, solar panels SP, roof windows RW, and roof vents RV. The example heating system 100, further includes a heating cable 102, and a fastening system 104. The example fastening system 104, includes adhesive clip 106, and other clips 108.

In the example of FIG. 1, the heating system 100, operates to provide heat to portions of the roof R, to prevent and reduce the buildup of ice dams.

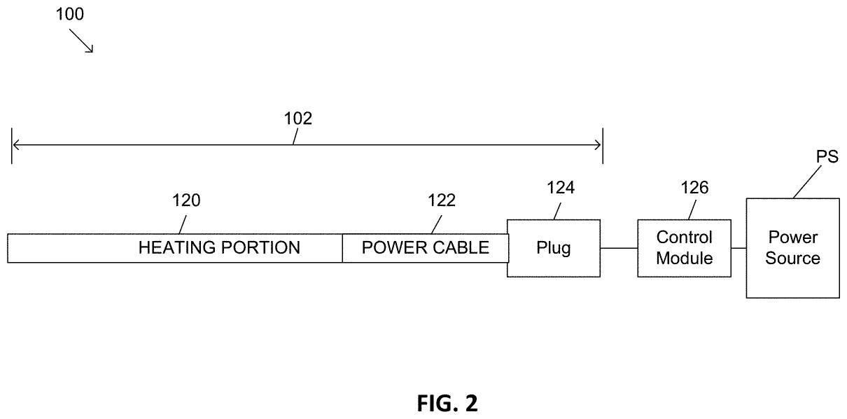

In some embodiments the heating system 100, includes a heating cable 102. The heating cable 102, heats to a temperature that is able to melt, or prevent freezing of, precipitation in contact with, or in close proximity to, the heating cable 102. The heating cable 102, is generally able to withstand high and low environmental temperatures experienced by the roof R. The heating cable 102, can be switched between an “on” state, in which a heating element within the heating cable 102, performs a heating function, and an “off” state, in which no heat is generated by the heating cable 102. Further description of the heating cable 102, configurations and heating functions is provided in conjunction with FIGS. 2-5 of the present application.

Although the heating cable 102, can be arranged in various configurations, in the example heating system 100, shown on building B, in FIG. 1, the heating cable 102, is powered by plugging a power plug at one end of the heating cable 102, into the outlet of the power source PS, of the building B. The remaining length of the heating cable 102, is then configured to be routed up through the vertical downspout section of the gutter G towards the roof R of the building B. The heating cable 102, is further routed through the horizontal sections of the gutter G, at the top of the vertical downspout, and around other areas of the roof R. In some embodiments, the heating cable 102, is oriented to run in a zig-zag pattern along the edge section of the roof R, surface, so that upper peaks of the zig-zag are formed at a position on the roof R, above the lower valleys of the zig-zag. The valleys of the zig-zag are then placed in a position where they overlap with the edge of the roof so that the melted channels formed by the heating cable 102, direct liquid precipitation off of the surface of the roof R. Thus, in the case that the roof R, also includes a gutter G, the precipitation is able to flow into the gutter G, along its horizontal length, and down the downspout, while remaining heated, and in its liquid state, by the heating cable 102, routed therein.

In some cases, the building B may include various features such as a gutter valley GV, solar panel SP, roof window RW, or roof vent RV. Depending on the unique characteristics of the roof R, or its features GV, SP, RW, RV, ice dams may be increasingly prone to forming around these areas. In such cases, the heating cable 102, is further routed along and around these features as to prevent ice from forming thereon. In some examples, the heating cable 102, is routed up and down the length of the gutter valley GV, around or on top of the solar panels SP, or roof window RV, and around or along the roof vent RV.

The fastening system 104, is used to secure the heating cable 102, to the building B. In some embodiments the fastening system 104, includes at least one adhesive clip 106, and may also include a variety of types of other clips 108.

The adhesive clips 106, or other clips 108, function to fasten the heating cable 102, to portions of the building B, such as the roof R, gutter G, and other roof features GV, SP, RW, RV. In this example, the adhesive clips 106, are used to route the heating cable 102, within the vertical downspout section and horizontal sections of the gutter G, as previously described. The adhesive clips 106, and other clips 108, may also be placed directly on the roof R, surface and staggered apart from one another in both the vertical and horizontal directions along the length of the gutter G, gutter valleys GV, and other roof features SP, RW, RV. Thus, the heating cable 102, can be routed and secured around the staggered adhesive clips 106, and other clips 108, of the fastening system 104, in different configurations as to generate optimal melt patterns.

Based on the materials and features of roof R, of the building B, different types of clips 106, 108, may be better suited for use with the heating system 100. For example, roofs with cedar shakes, asphalt shingles, synthetic shakes, or natural or synthetic slate may be more compatible with other clips 108, such as traditional nail-on roof clips or slide-on roof clips, whereas corrugated metal roofs may be more compatible with other clips 108, such as corrugated specific roof clips. Similarly, gutter section interiors may be more compatible with other clips 108, such as gutter separators or downspout clips.

However, certain roof features may still render certain sections of the roof less compatible with these previously described types of other clips 108. For example, solar panels SP, gutters G, gutter valleys GV, roof windows RW, and roof vents RV, all typically contain flat, ridged surfaces that may not provide proper traction for a slide-on roof clip and may not be nailed into with a traditional nail-on clip. Unfortunately, ice dams may still form around these features and cause damage. Thus, the heating system 100, allows the heating cable 102, to be routed around these areas. Adhesive clips 106, may be desirable, as they are better equipped to adhere to these roof features with smooth, flat, and ridged surfaces. As seen in FIG. 1, the adhesive clips 106, are attached to the gutter G, gutter valley GV, solar panel SP, roof window RW, and roof vent RV of the roof R as to route the heating cable 102, around these areas. Roof feature surfaces compatible for mounting an adhesive clip 106, thereon include: the one or more flat surfaces of the gutter valley GV, the flat bottom or side surfaces of the interior or exterior of the gutter G, the side surfaces of the solar panel SP, housing or top surface of the solar panel SP, itself, the side surfaces of the roof window RW housing or the window surface of the roof window RW, the base portion of the roof vent RV, or any other smooth flat surface on any roof feature large enough for the adhesive clip 106, to attach to.

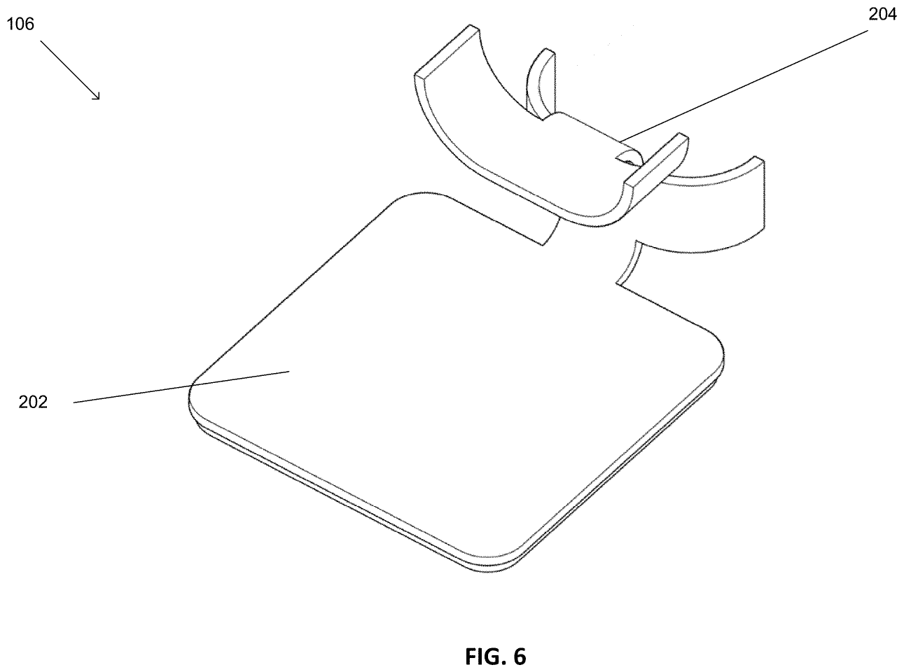

In some embodiments, the adhesive clips 106, include a flat base portion and a cable cradle. The flat base portion further includes a base plate and an adhesive portion. The adhesive portion is connected to roof features by placing the adhesive portion in contact with a smooth flat surface of a roof feature G, GV, SP, RW, or RV. Further description of the adhesive clip 106, and methods of installing the adhesive clip 106, are illustrated and described in further detail with reference to FIGS. 6-14 and FIGS. 18-27 of the present application.

FIG. 2 is a diagram of a portion of the example heating system 100, of FIG. 1, including the heating cable 102. In this example, the heating cable 102, includes a heating portion 120, a power cable 122, a plug 124, and a control module 126. A power source PS, is also shown.

The heating portion 120, of the heating cable 102, is configured to heat up when the heating cable 102, is placed under power. The heating portion 120, thereby heats to temperatures capable of melting ice dams in contact with, or in close proximity to the heating portion 120, of the heating cable 102. At one end, the heating portion 120, of the heating cable 102, contains a termination point, whereas at the other end, the heating portion 120, connects to the power cable 122, of the heating cable 102.

In some embodiments, the heating cable 102, includes a power cable 122. The power cable 122, extends between the heating portion 120, and the plug 124, of the heating cable 102. In some embodiments, the power cable 122, takes the form of an extension cord. Both the power cable 122, and the plug 124, are configured to remain unheated while delivering electrical power to the heating portion 120, of the heating cable 102. This allows the power cable 122, to be routed over areas that could potentially be damaged, or ignited, if they were to be in close contact with the heating portion 120, of the heating cable 102. Thus, the heating cable 102, may be safely routed from a site near the outlet of the power source PS, to the gutter G, so that only areas that are intended to be in contact with the heating portion 120, of the heating cable 102, are heated.

The plug 124, of the heating cable 102, functions to connect the power cable 122, to the control module 126, so that the heating cable 102, is supplied with power. In some embodiments, the plug 124, may be plugged directly into the power source PS, without the use of the control module 126.

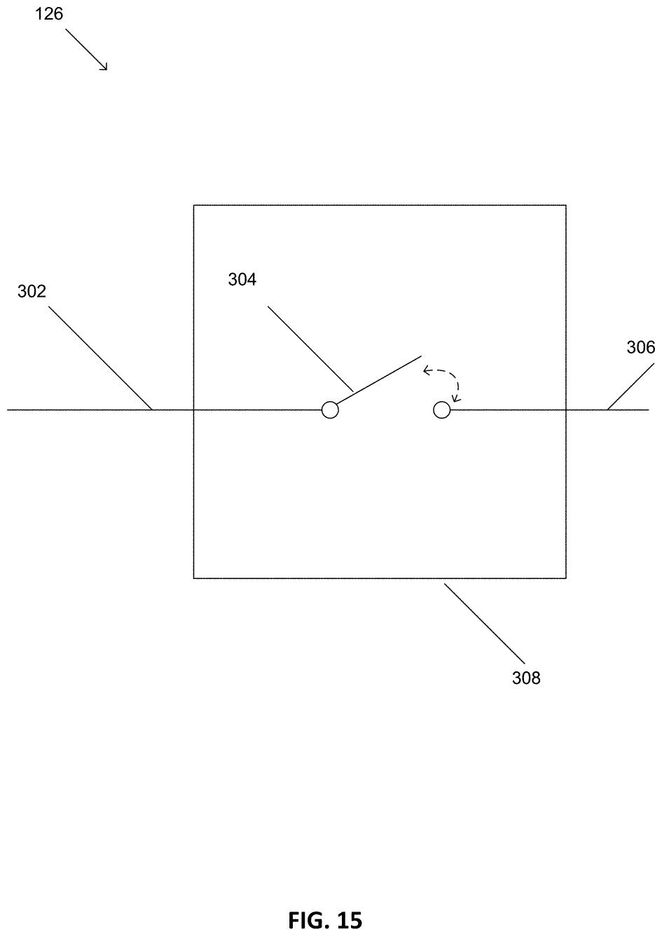

The control module 126, controls the delivery of electrical power from the power source PS, to the plug 124, of the heating cable 102. In some embodiments, the control module 126, is configured so that it functions as a switch, wherein in the presence of certain environmental conditions the switch is closed, as to provide power to the heating cable 102, and in the absence of the certain environmental conditions the switch is opened, as to prevent power from reaching the heating cable 102. The control module 126, may be connected to the power source PS, through an electrical plug 124, and outlet. Thus, the power source PS, continuously provides power to the control module 126, while the control module 126, selectively modulates the power supplied to the heating cable 102. Thus, the heating capability of the heating portion 120, of the heating cable 102, may be modulated by the presence and absence of the certain environmental conditions using the control module 126. Additional description of the control module 126, is provided in conjunction with FIGS. 15-17 of the present application.

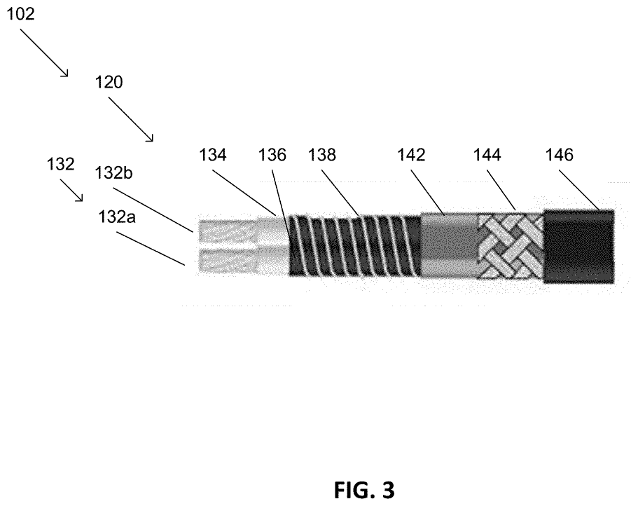

FIG. 3 is a side view of an example heating portion 120, of the heating cable 102, which may be used with the heating system 100, of FIG. 1 or FIG. 2. In the embodiment of FIG. 3, the heating portion 120, of the heating cable 102, includes a pair of bus wires 132, a first insulating coating 134, an inner sheath 136, resistance wires 138, a second insulating coating 142, a metallic overbraid 144, and an overjacket 146.

The heating portion 120, of the example of FIG. 3 is able to operate so that a constant level of power is consumed by the heating cable 102, while supplied with power by the power source PS. Thus, the heating portion 120, heats at a relatively constant temperature while supplied with a constant amount of power.

In the example embodiment of FIG. 3, the two conductive bus wires 132a, 132b, conduct electricity delivered from the power source PS, and extend along the length of the heating portion 120. The bus wires 132, may be formed from, for example, 12 AWG copper wire. Each bus wire 132, is electrically connected to a different electrical terminal of the power source PS, so that one bus wire 132a is kept at different voltage levels from the other bus wire 132b.

The first insulating coating 134, is wrapped around the circumference of each bus wire 132, and extends along the length of the bus wires 132. The first insulating coating 134, may be made from 11 mil fluorinated ethylene propylene jacket, but could also be made from other nonconductive materials such as plastic, rubber-like polymers, or varnish. Being placed around the conductive bus wires 132, the first insulating coating 134, prevents electrical shorts from occurring between the bus wires 132, and other electrical components within the heating portion 120.

An inner sheath 136, is then formed around the combined width of the two partially insulated bus wires 132, and serves to hold the bus wires 132, together. The inner sheath 136, extends along the length of the heating portion 120, of the heating cable 102. The inner sheath 136, also serves as a wrapping surface for the resistance wire 138, to be wrapped around the two bus wires 132.

The resistance wire 138, is the heating component of the heating portion 120, of the heating cable 102, of the example of FIG. 3. In some embodiments, the resistance wire 138, is made from, for example, 24 AWG Nichrome (Nickel Chromium) wire and has a resistance value of approximately 2.57 Ohms per foot. The resistance wire 138, is wrapped around the wrapping surface of the inner sheath 136, along the length of the pair of bus wires 132.

A second insulating coating 142, is then wrapped around the outer surface of the bus wire 132, first insulating coating 134, inner sheath 136, and resistance wire 138, assembly. Like the first insulating coating 134, the second insulating coating 142, may also be made from a fluorinated ethylene propylene jacket, or other electrically insulating materials. The second insulating coating 142, allows for the prevention of incidental electrical contact of the resistance wires 138, and bus wires 132, with any other components.

A metallic overbraid 144, is woven over the surface of the second insulating coating 142. The metallic overbraid 144, is electrically grounded as to provide a failsafe electrical grounding pathway in case any of the electrically charged elements of the heating cable 102, assembly make contact with the metallic overbraid 144. The metallic overbraid 144, also serves to provide additional structural support and protection for the heating cable 102. The metallic overbraid 144, may, for example, be formed from a plated copper material.

Lastly, the entire assembly is wrapped again with an overjacket 146, as to provide an additional layer of environmental protection to the heating cable 102. The overjacket 146, may also be formed from a fluorinated ethylene propylene jacket or other insulating material.

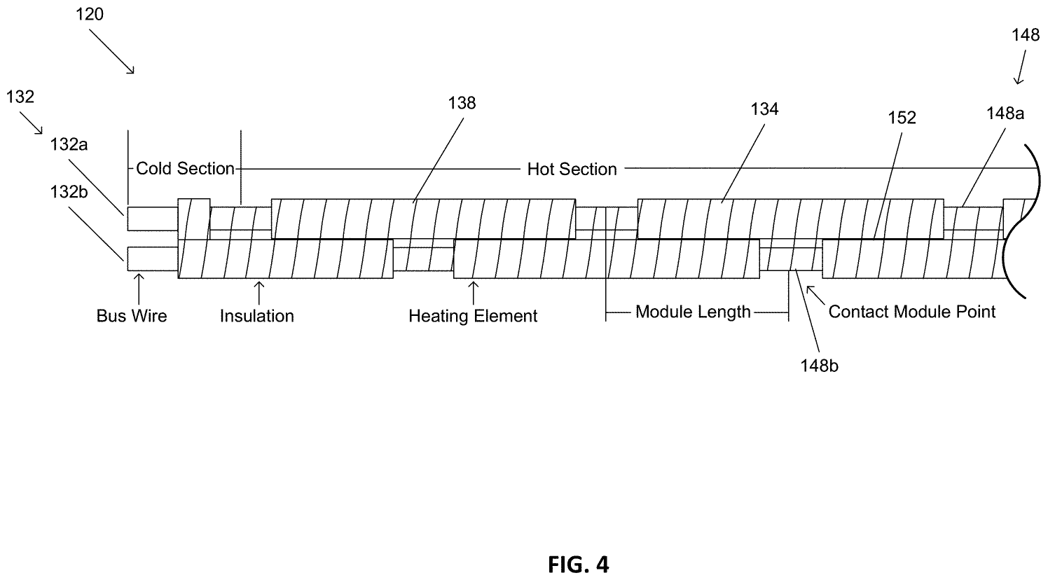

FIG. 4 is a side view of the bus wires 132, the first insulating coating 134, and the resistance wires 138, of the example heating portion 120, of FIG. 3. In the embodiment of FIG. 4, the heating portion 120, further includes first stripped length 148a, a second stripped length 148b, and fully insulated lengths 152.

As described above with reference to FIG. 3, the bus wires 132, are coated with a first insulating coating 134. However, at certain sections along the length of the heating portion 120, a first stripped length 148a of the first insulating coating 134, is stripped from the first bus wire 132a, as to leave a first stripped length 148a, non-insulated. The second bus wire 132b, still retains its first insulating coating 134, along the first stripped length 148a, but another portion of the first insulating coating 134, is stripped from a second stripped length 148b, of the second bus wire 132b. The first and second stripped lengths 148, may repeat periodically along the length of the bus wires 132a, 132b, so that sections of the heating portion 120, of the heating cable 102, consists of fully insulated lengths 152, first stripped lengths 148a, and second stripped lengths 148b. The first and second stripped lengths 148, are oriented as to not overlap along the length of the heating cable 102, which serves to prevent electrical shorts from occurring.

The exposed resistance wire 138, wrapped around the pair of bus wires 132, is configured to make electrical contact with a bus wire 132a, 132b, at the first and second stripped lengths 148a, 148b, while remaining electrically insulated from the bus wires 132, along the fully insulated lengths 152. Thus, the resistance wire 138, conducts electricity from the first bus wire 132b, from its contact point at the first stripped length 148a, along the fully insulated length 152, to the second bus wire 132b, at the second stripped length 148b. The current flowing through the resistance wire 138, along the fully insulated length 152, of the pair of bus wires 132, causes the resistance wire 138, to heat up. Because the resistance value of the resistance wire 138, remains generally constant, as the voltage differential between the bus wires 132, is increased, the amount of current flowing through the resistance wire 138, along the fully insulated length 152, increases. Because the temperature of the resistance wire 138, generally increases as the current flowing through it is increased, the temperature of the heating portion 120, of the heating cable 102, can be precisely controlled by incrementally varying the voltage differential supplied to bus wires 132.

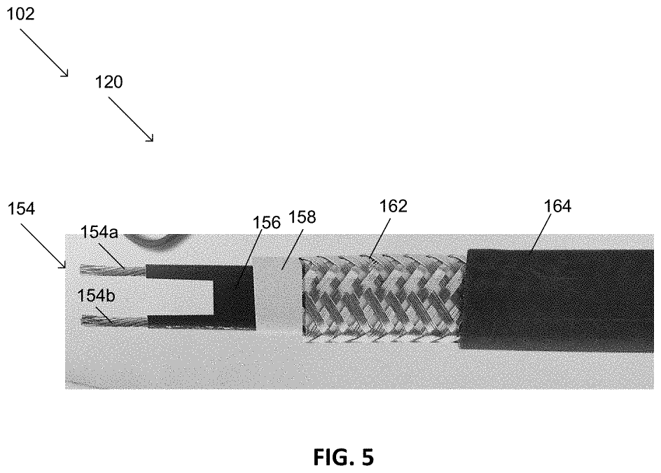

FIG. 5 is a side view of a heating portion 120, of another example heating cable 102, which may be used with the heating system 100, of FIG. 1 or FIG. 2. In the embodiment of FIG. 5 the heating portion 120, of the heating cable 102, includes a pair of bus wires 154, a self-regulating heating element 156, an insulating coating 158, a metallic overbraid 162, and an overjacket 164.

The heating portion 120, of the example of FIG. 5 is self-regulating based on the environmental temperatures that it is exposed to. Thus, in instances where the heating cable 102, is placed in warmer temperatures, the heating portion 120, will draw less power and generate less heat than in instances where the heating cable 102, is placed in cooler temperatures.

Similar to the example embodiment of FIG. 3, the two conductive bus wires 154a, 154b, conduct electricity delivered from the power source PS, and extend along the length of the heating portion 120. The bus wires 154, may be formed from, for example, 12 AWG copper wire. Each bus wire 154, is electrically connected to a different electrical terminal of the power source PS, so that one bus wire 132a is kept at different voltage levels from the other bus wire 132b.

The self-regulating heating element 156, coats, and extends between, the circumferences of the bus wires 154. The self-regulating heating element 156, is formed, for example, from a semi-conductive polymer heating matrix.

The insulating coating 158, is wrapped around the circumference of the bus wire 154, and self-regulating heating element 156, assembly, and extends along the length of the bus wires 154. The insulating coating 158, may be made from a fluorinated ethylene propylene jacket, but could also be made from other nonconductive materials such as plastic, rubber-like polymers, or varnish. Being placed around the semi-conductive, self-regulating heating element 156, the insulating coating 158, prevents electrical connections from forming between the bus wire 154, and self-regulating heating element 156, assembly and other conductive components within the heating portion 120.

A metallic overbraid 162, is woven over the surface of the insulating coating 158. The metallic overbraid 162, is electrically grounded as to provide a failsafe electrical grounding pathway in case any of the electrically charged elements of the heating cable 102, assembly make contact with the metallic overbraid 162. The metallic overbraid 162, also serves to provide additional structural support and protection for the heating cable 102. The metallic overbraid 162, may, for example, be formed from a plated copper material.

Lastly, the entire assembly is wrapped again with an overjacket 164, as to provide an additional layer of environmental protection to the heating cable 102. The overjacket 164, may also be formed from a fluorinated ethylene propylene jacket or other insulating material.

One property of the self-regulating heating element 156, within the heating cable 102, of the example embodiment of FIG. 5, is that its resistance increases as the environmental temperature to which it is exposed to increases. Likewise, as the environmental temperature decreases, so does the resistance value of the self-regulating heating element 156. In the example embodiment of FIG. 5, electrical current flows through the self-regulating heating element 156, between the bus wires 154, due to the voltage differential between the bus wires 154. As the resistance levels of the self-regulating heating element 156, decrease, the current flowing between the bus wires 154, increases. The current flowing through the self-regulating heating element 156, has the effect of causing the self-regulating heating element 156, to generate heat. Thus, as the environmental temperature in which the heating cable 102, is placed in decreases, the resistance of the self-regulating heating element 156, decreases, and the heat produced by the heating element 156, is increased as a product of the increased current flowing within it. Likewise, as the environmental temperature is increased, the heat produced by the heating element 156, decreases.

The resistance values of the self-regulating heating element 156, may vary along the length of the heating portion 120, of the heating cable 102, depending on the local environmental temperatures that a given length is exposed to. Thus, in the event that different sections of the heating portion 120, experience different temperatures, the heat generated by the self-regulating heating element 156, may vary along the length of the heating portion 120.

Because the heating system 100, is used to melt frozen precipitation, at temperatures above freezing, it may be undesirable for the heating portion 120, to produce heat due to the lack of frozen precipitation. As the temperature and resistance of the self-regulating heating element 156, increases, and the current flowing through it decreases, both the heat generated and the amount of power consumed by the heating portion 120, decreases. Thus, the heating cable 102, of FIG. 5 may be useful in cases where the operator of the heating system 100, wishes to cease operation of the heating portion 120, and conserve electrical power without having to manually adjust the amount of power supplied to the heating cable 102.

FIG. 6 is a perspective view of an example adhesive clip 106, of the example fastening system 104, of FIG. 1. The example adhesive clip 106, includes a base portion 202, and a cable cradle 204.

The adhesive clip 106, is configured to support a heating cable 102, on a building B.

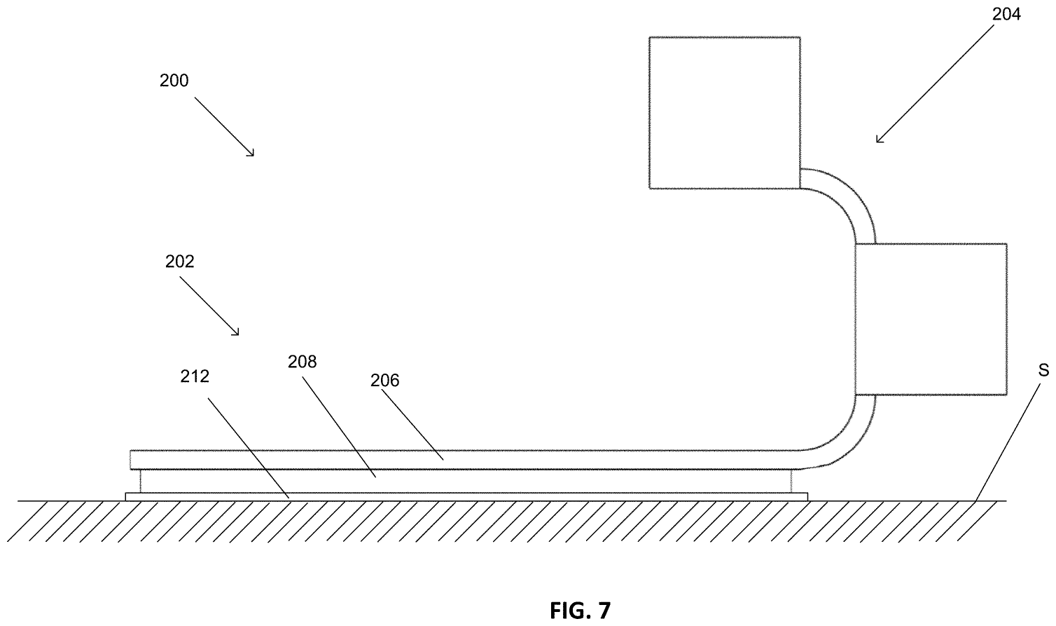

FIG. 7 is a right side view of another example adhesive clip 106. In this example, the adhesive clip 106, includes the base portion 202, and the cable cradle 204. The base portion 202, further includes a base plate 206, an adhesive portion 208, and an adhesive cover 212.

The base portion 202, is configured to be attached to a surface of a building and support the cable cradle 204.

The base plate 206, of the base portion 202, has a top and bottom surface. The top and bottom surface of the base plate 206, are configured to be generally flat. The height dimension of the base plate 206, is further configured to be less than the length dimension and width dimension of the base plate 206.

The adhesive portion 208, is deposited upon the bottom surface of base plate 206. In some embodiments, the adhesive portion 208, is configured to generally cover the entire bottom surface of the base plate 206. The adhesive portion 208, is configured to adhere to both the base plate 206, and a surface underneath the base plate 206, as to secure the base plate 206, to the surface. In some embodiments the adhesive portion 208, is configured to adhere to smooth flat surfaces such as rubber membranes, metallic surfaces, and glass surfaces. The adhesive portion 208, is further configured to be removable without damaging the surface that it was previously adhered to.

In some embodiments, the adhesive portion 208 can support up to 35 pounds of loads carried by the cable cradle 204. In some embodiments the adhesive portion 208 can support a weight in a range from 0 to 50 pounds, in other embodiments a weight in a range from 0 to 40 pounds, in other embodiments a weight from 0 to 30 pounds, and in other embodiments a weight from 0 to 35 pounds.

In some embodiments the adhesive portion 208 has a working temperature range that includes a temperature range from 200° F. to −40° F. In another embodiment, the working temperature range is from 150° F. to −30° F.

In some embodiments, the adhesive portion 208 is formed of glue, epoxy, a double sided tape, a double sided adhesive layer, or a double sided adhesive pad. In other embodiments, the adhesive portion 208 includes a 6 mm thick, closed-cell acrylic double sided foam tape with a modified acrylic type adhesive.

In some embodiments a thickness of the adhesive portion 208 is in a range from 1 mm to 10 mm, in another embodiment in a range from 2 mm to 8 mm, and in another embodiment in a range from 4 mm to 8 mm, or about 6 mm.

Some embodiments of adhesive portion 208 include a closed-cell acrylic double sided foam tape. Some embodiments of adhesive portion 208 include an acrylic adhesive.

The adhesive cover 212, is placed over the bottom surface of the adhesive portion 208. The adhesive cover 212, generally extends over the entire adhesive portion 208, and may extend past the edges of the adhesive portion 208. The adhesive cover 212, is configured to be removable from the adhesive portion 208, in a way that does not detract from the adhesive properties of the adhesive portion 208. For example, the adhesive cover 212, may be peeled off of the adhesive portion 208. The adhesive cover 212, serves to protect the adhesive portion 208, from collecting debris, which has the potential to negatively affect the adhesive qualities of the adhesive portion 208. The adhesive cover 212, further protects the adhesive portion 208, from accidentally being stuck to surfaces or objects during transportation or storage, prior to its final application.

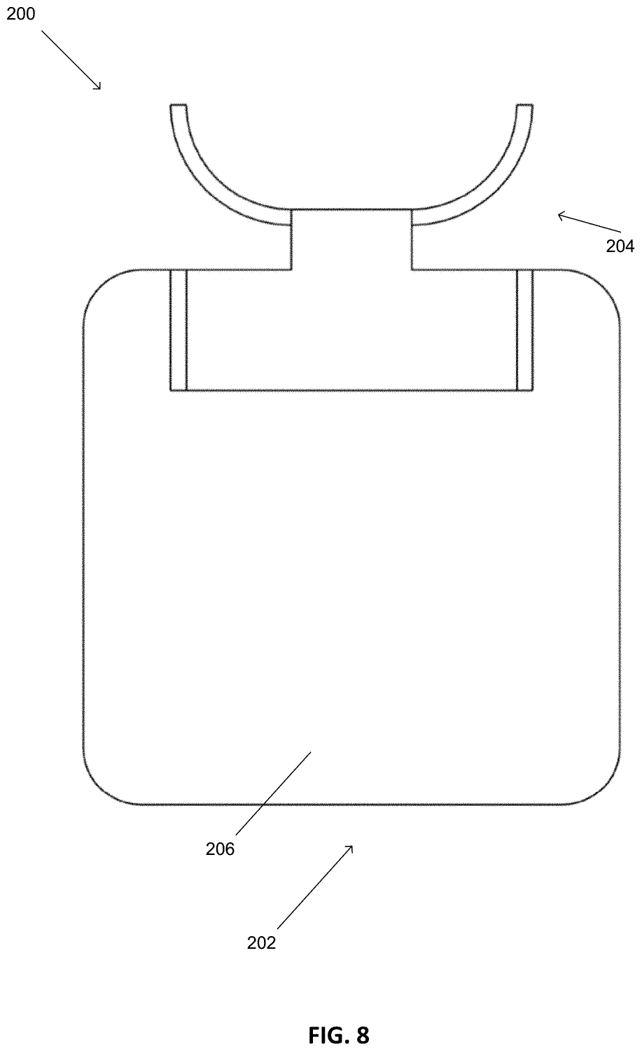

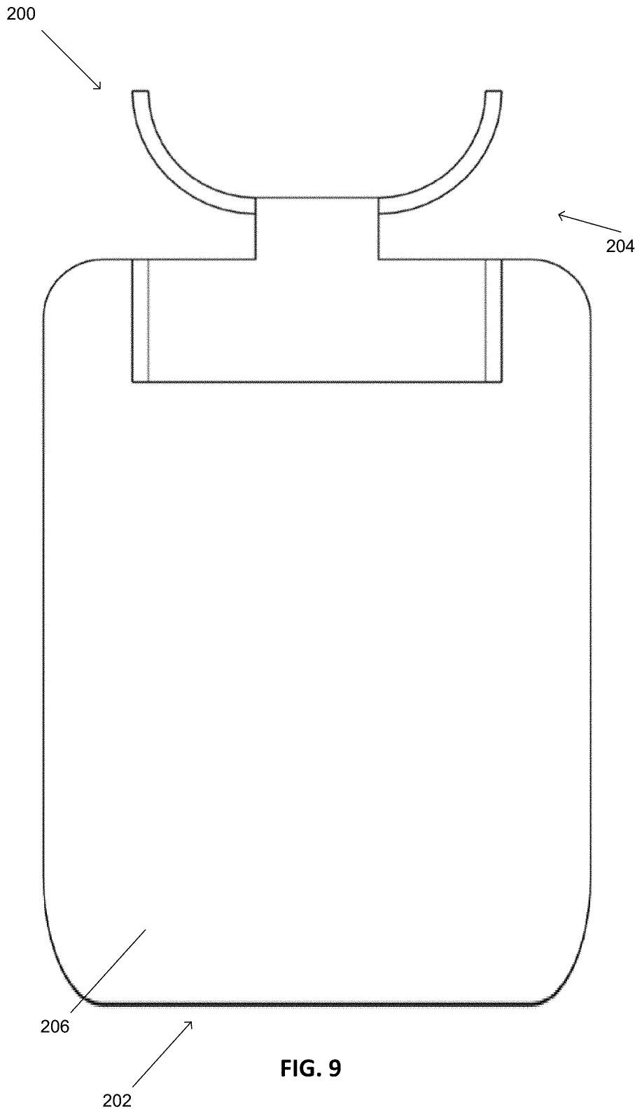

FIGS. 8 and 9 are top views of additional example adhesive clips 106, including a base portion 202, with a base plate 206. As depicted, in some embodiments, the base plate 206, has a generally rectangular shape. However, the shape of the base plate 206, may be varied depending on the application in which it is used. For example, in some cases, the base plate 206, may be circular in shape or may have a more elongated rectangular shape (as shown in FIG. 9).

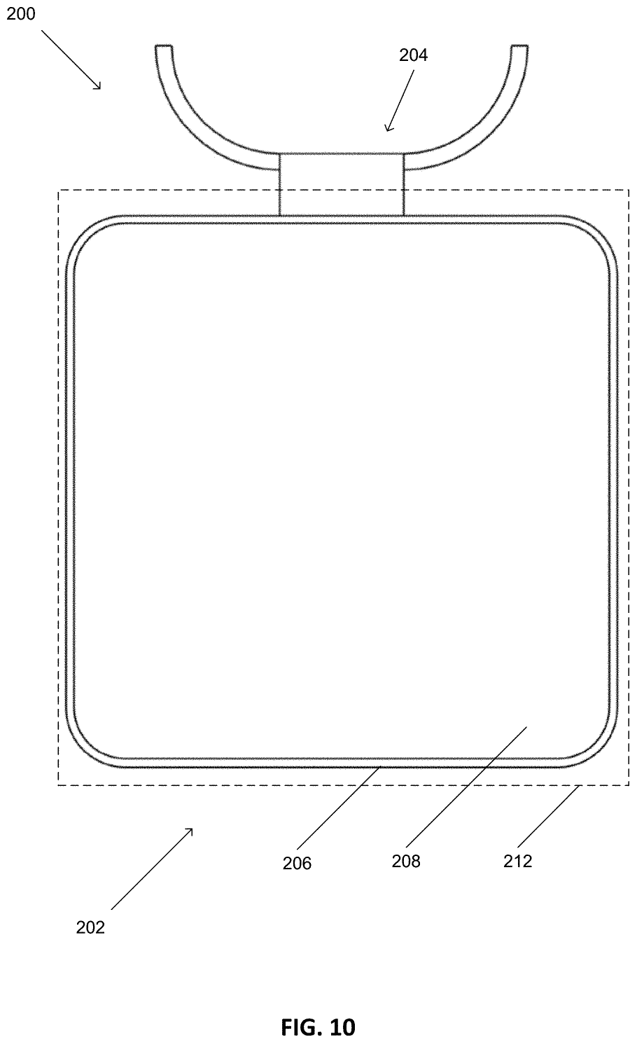

FIG. 10 is a bottom view of another example adhesive clip 106, also including a base plate 206, an adhesive portion 208, and an adhesive cover 212.

As depicted in FIG. 10, in some embodiments, the adhesive portion 208, is configured as to cover the entire bottom surface of, and take generally to the same shape of, the base plate 206. However, the adhesive portion 208, may be further configured as to only cover a portion of the bottom surface of, and take a different shape from, the base portion 202.

Further, in some embodiments, the adhesive cover 212, is configured to cover the entire bottom surface of the adhesive portion 208. In the embodiment of FIG. 10, the adhesive cover 212, further extends past the edge of the adhesive portion 208, and base plate 206, as to ease the removal of the adhesive cover 212.

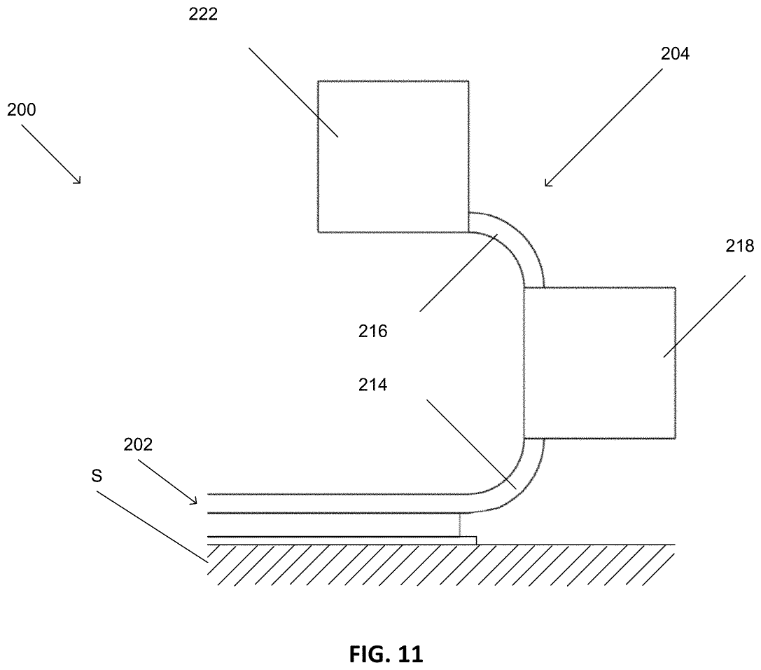

FIG. 11 is a right view of the cable cradle 204, of the adhesive clip 106, of FIG. 7. The cable cradle 204, includes a first neck 214, a first cable guide 218, a second neck 216, and a second cable guide 222.

The cable cradle 204, is configured to secure the heating cable 102, while the base portion 202, is attached to the surface.

In some embodiments, at one end, the first neck 214, connects to, and extends rearwardly from, the rear edge of the base plate 206, before bending upwardly. In some embodiments the first neck 214, has a curved shape so that its upper end is oriented vertically. In this embodiment, the first neck 214, is generally narrower in the left right direction than the base plate 206, and is centered along the rear edge of the base plate 206, in the left and right direction.

In some embodiments, at its uppermost end, the first neck 214, connects to the first cable guide 218. The first cable guide 218, then extends along its length upwardly in the vertical direction and includes a front and back surface. In some embodiments, the first cable guide 218, includes curved rearwardly extending wings. The first cable guide 218, is configured to have an equal thickness with that of the first neck 214.

At its uppermost end, the first cable guide 218, connects to the second neck 216. The second neck 216, extends upwardly from the upper edge of the first cable guide 218, before bending frontwardly. In some embodiments the second neck 216, has a curved shape so that its upper end is oriented horizontally. In this embodiment, the width of the second neck 216, is equal to the width of the first neck 214, and the thickness of the second neck 216, is equal to that of the first cable guide 218, and the first neck 214.

In some embodiments, at its frontmost end, the first neck 214, connects to the second cable guide 222. Thus, the second cable guide 222, then extends along its length frontwardly in the horizontal direction and includes a top and bottom surface. In some embodiments, the second cable guide 222, includes curved upwardly extending wings. The second cable guide 222, is configured to have an equal thickness with that of the second neck 216, first cable guide 218, and first neck 214.

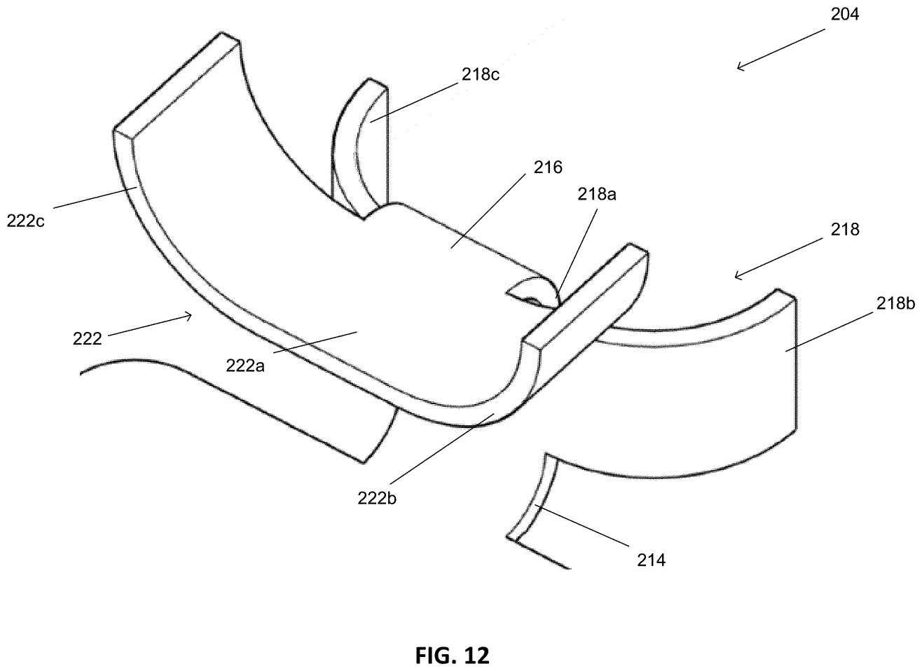

FIG. 12 is a perspective view of the cable cradle 204, of the adhesive clip 106, of FIG. 6. Similarly to FIG. 11, the cable cradle 204, includes a first neck 214, a first cable guide 218, a second neck 216, and a second cable guide 222. Both the first cable guide 218, and the second cable guide 222, each further include a central portion 218a, 222a, a rightwardly extending wing 218b, 222b, and a leftwardly extending wing 218c, 222c.

Referring to the first cable guide 218, the central portion 218a, connects to the rightwardly extending wing 218b on its right side, the leftwardly extending wing 218c on its left side, the first neck 214, on its bottom side, and the second neck 216, on its top side. In some embodiments, the length of the central portion 218a, is greater than the length of the rightwardly and leftwardly extending wings 218b, 218c, connected along its length in the vertical direction. Thus, the rightwardly extending wing 218b and the leftwardly extending wing 218c may positioned so that they are centered along the length of the central portion 218a. Further, in some embodiments, the central portion 218a, is configured to be a generally flat surface with a width and thickness substantially equal to that of the first neck 214, and second neck 216, the flat surface being oriented as to be generally perpendicular with that of the base plate 206.

The leftwardly extending wing 218c of the first cable guide 218, has a length that protrudes leftwardly from the left side of the central portion 218a, and curves in a rearwardly direction. In some embodiments the leftwardly extending wing 218c, takes the shape of a rectangular surface curved along its length.

Likewise, the rightwardly extending wing 218b, of the first cable guide 218, has a length that protrudes rightwardly from the right side of the central portion 218a, and also curves in the rearwardly direction. In some embodiments the rightwardly extending wing 218b, also takes the shape of a rectangular surface curved along its length.

Referring now to the second cable guide 222, the central portion 222a, connects to the rightwardly extending wing 222b, on its right side, the leftwardly extending wing 222c, on its left side, and the second neck 216, on its rear side. In some embodiments, the length of the central portion 222a, is greater than the length of the rightwardly and leftwardly extending wings 222b, 222c, connected along the length of the central portion 222a, in the vertical direction. The second cable guide 222, is then further configured so that the frontmost edge of the central portion 222a, rightwardly extending wing 222b, and leftwardly extending wing 222c, are all congruent and form a termination point for the cable cradle 204. Further, in some embodiments, the central portion 222a, is configured to be a generally flat surface with a width and thickness substantially equal to that of the first neck 214, and second neck 216, the flat surface being oriented as to be generally parallel with that of the base plate 206.

In some examples, the leftwardly extending wing 222c, of the second cable guide 222, has a length that protrudes leftwardly from the left side of the central portion 222a, and curves in an upwardly direction. In some embodiments the leftwardly extending wing 222c, takes the shape of a rectangular surface curved along its length.

Likewise, the rightwardly extending wing 222b, of the second cable guide 222, has a length that protrudes rightwardly from the right side of the central portion 222a, and also curves in the upwardly direction. In some embodiments the rightwardly extending wing 222b, also takes the shape of a rectangular surface curved along its length.

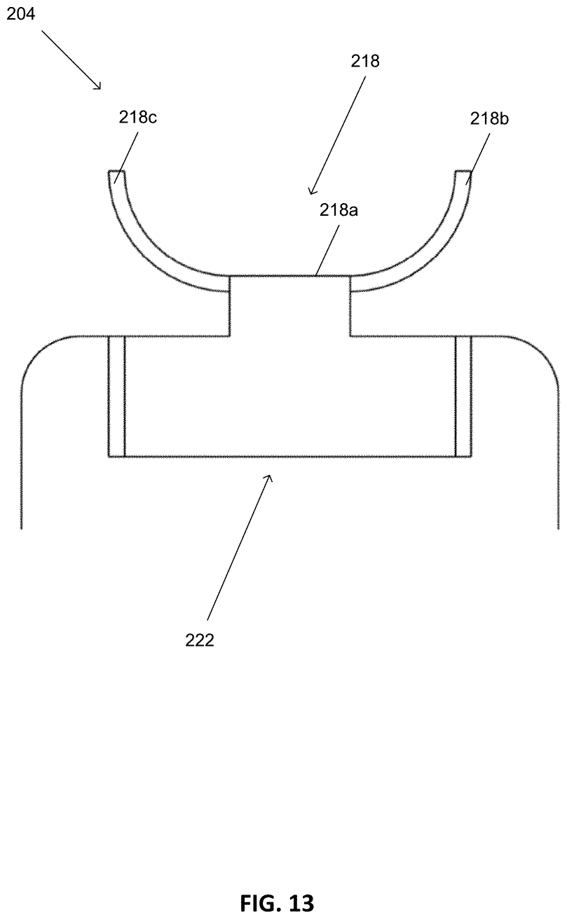

FIG. 13 is a top view of the example cable cradle 204, of the adhesive clip 106, of FIG. 6. In this example, the wings 218b, 218c, of the first cable guide 218, terminate at a position where the wings 218b, 218c, are extending in a horizontal and rearwardly direction.

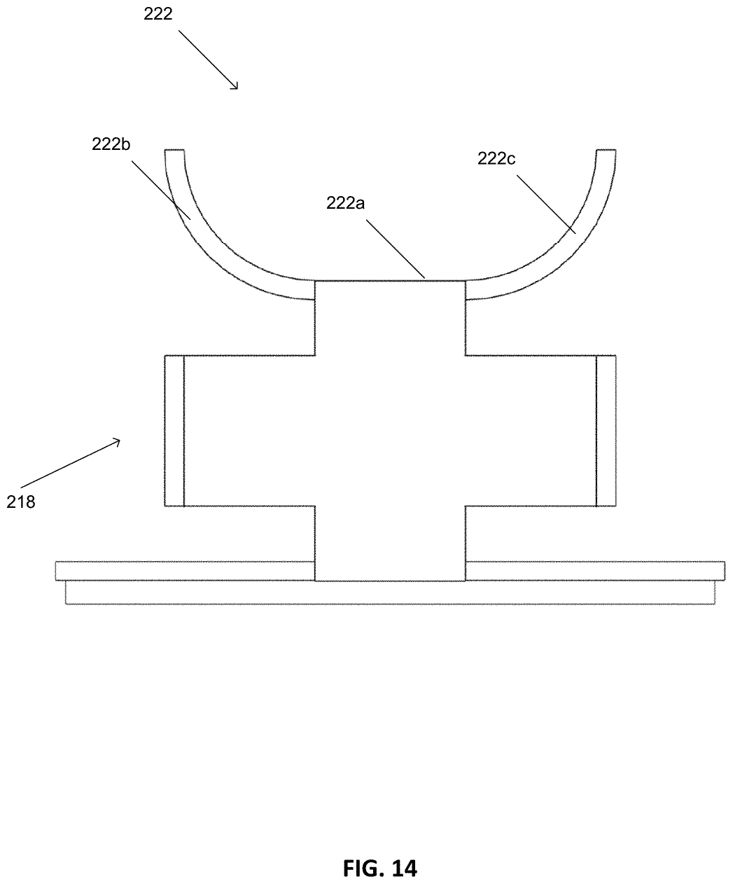

Likewise, FIG. 14 is a rear view of the example cable cradle 204, of the adhesive clip 106, shown in FIG. 6. In this example, the wings 222b, 222c, of the second cable guide 222, terminate at a position where the wings 222b, 222c, are extending in a vertical and upwardly direction.

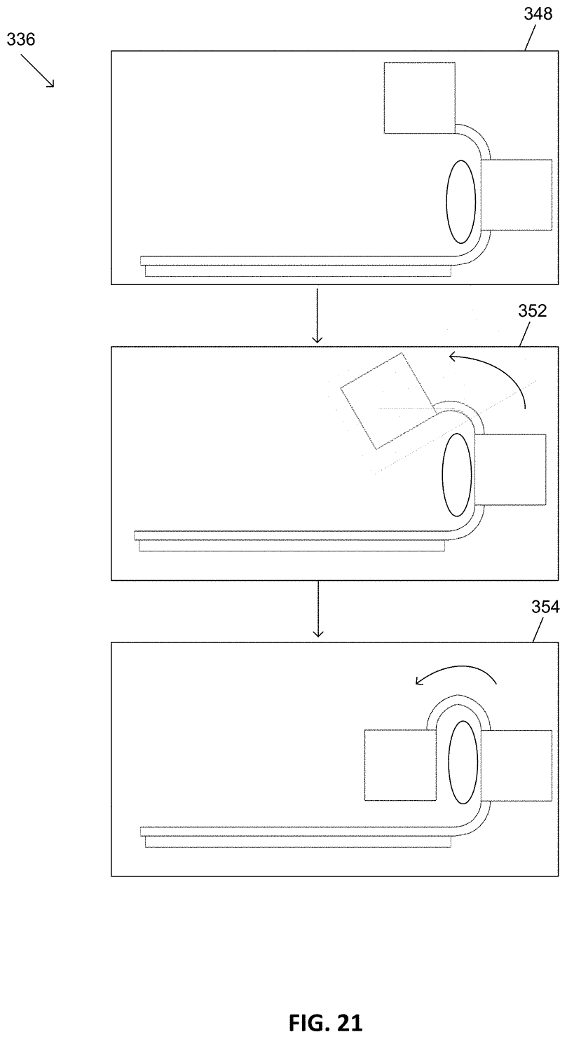

The base plate 206, and cable cradle 204, of the adhesive clip 106, may be formed from a variety of materials including for example, aluminum alloy AL5052 or other anodized aluminums. Further, the cable cradle 204, of the adhesive clip 106, may be configured so that it is bendable along the first neck 214, and second neck 216, and does not exhibit serious damage after bending from an open to closed position (as depicted in FIG. 21). Lastly, although bendable, the cable cradle 204, is further configured to hold the shape that it is bent into, so that a user is generally required to bend the cable cradle 204, between an open position and a closed position.

FIG. 15 is a schematic view of an example control module 126, of the example heating system 100, of FIG. 2. The example control module 126, includes an input 302, a switch 304, an output 306, and a housing 308.

The control module 126, is used to modulate the power delivered to the heating cable 102, by a power source PS, in response to environmental conditions.

In some embodiments, the input 302, of the control module 126, is configured to connect to the power source PS, via an electrical plug. The plug may be plugged into an outlet of the power source PS, so that different terminals of the power source PS, are connected to electrically isolated inputs 302. One or more of the inputs 302, may then be connected to one or more switches 304, within the control module 126.

In some embodiments, the switch 304, may alternated between two different states. First, the switch 304, may be positioned in a closed position, in which the switch 304, supplies power to the output 306, or an open position, in which the supply of power to the output 306, is cut off In some embodiments, the switch 304, is controlled by an internal air temperature sensor, which senses the ambient air temperature so that the switch 304, is turned to a closed position when the temperature drops below 35° F., and an open position when the temperature rises above 45° F.

The switch 304, is connected at its other end to an output 306. The output 306, routes the electrical power supplied by the input 302, and switch 304, to another device, such as the heating cable 102, which may be connected thereto. In some embodiments, the output 306, of the control module 126, may terminate in a standard electrical outlet, which other devices may be plugged into with an electrical plug and supplied with power.

In some embodiments, the switch 304, of the control module 126, is enclosed within a housing 308. The housing 308, seals the switch 304, and other electrical components within the control module 126, from external environmental elements such as snow or precipitation, as to prevent damage to the interior electrical components of the control module 126. In some embodiments, the housing 308, may be formed from plastic.

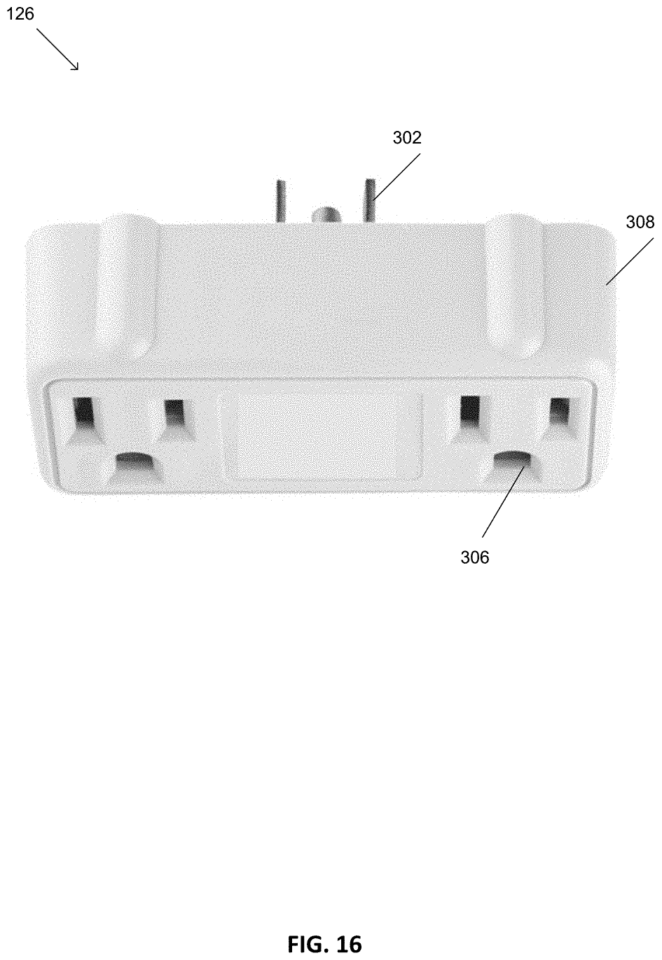

FIG. 16 is a perspective view of the example control module 126, of FIG. 15, illustrating the control module input 302, outputs 306, and housing 308. As previously described with reference to FIG. 15, the input 302, and output 306, are configured to be compatible with standard electrical outlets and plugs.

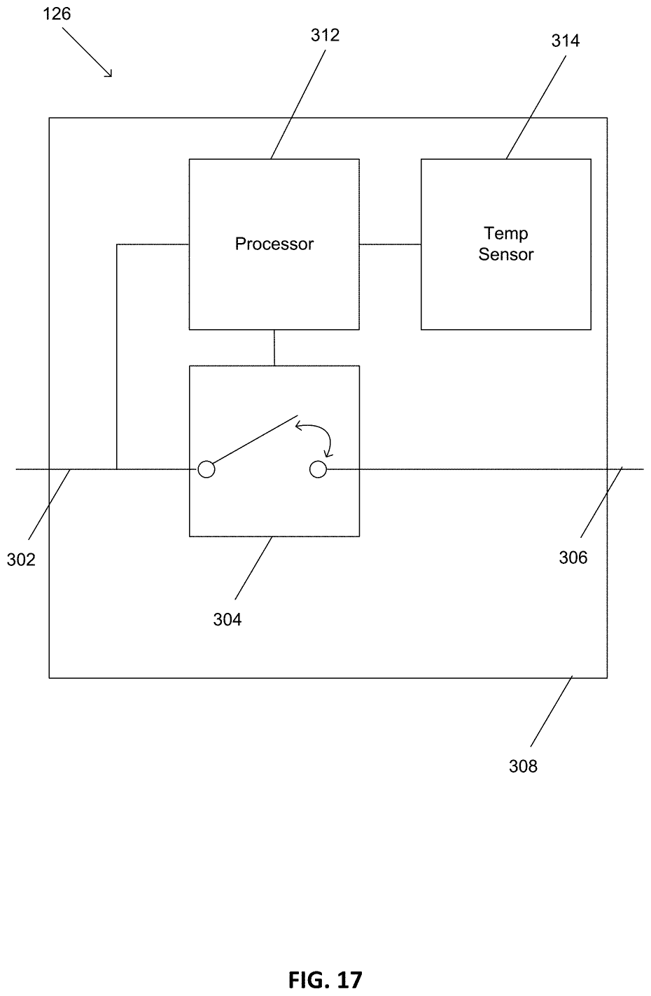

FIG. 17 is a schematic view of another example control module 126, of the example heating system 100, of FIG. 2. The example control module 126, includes an input 302, a switch 304, an output 306, a housing 308, a processor 312, and a temperature sensor 314.

In some embodiments, the input 302, of the control module 126, is configured to connect to the power source PS, via an electrical plug. The plug may be plugged into an outlet of the power source PS, so that different terminals of the power source PS, are connected to electrically isolated inputs 302. One or more of the inputs 302, may then be connected to one or more switches 304, within the control module 126.

The switch 304, is connected to the input 302, output 306, and processor 312. Like the example control module 126, described with reference to FIG. 15, the switch 304, may be positioned in a closed position, in which the switch 304, supplies power from the input 302, to the output 306, or an open position, in which the supply of power to the output 306, is cut off. The switch 304, is controlled by, and alternated between the open and closed position by, the processor 312.

The switch 304, is connected at its other end to an output 306. The output 306, routes the electrical power supplied by the input 302, and the switch 304, to another device which may be connected thereto. In some embodiments, the output 306, of the control module 126, may terminate in a standard electrical outlet, to which other devices may be plugged into with an electrical plug and supplied with power.

In some embodiments, the switch 304, processor 312, and temperature sensor 314, of the control module 126, is enclosed within a housing 308. The housing 308, seals the switch 304, and other electrical components within the control module 126, from external environmental elements such as snow or precipitation, as to prevent damage to the interior electrical components of the control module 126. In some embodiments, the housing 308, may be formed from plastic.

The processor 312, is connected to the input 302, so that it receives a constant supply of power from the power source PS, regardless of whether the switch 304, is placed in an open or closed position. The processor 312, can be any of a variety of types of programmable circuits capable of executing computer-readable instructions to perform various tasks, such as mathematical and communication tasks. The processor 312, is connected to and configured to receive signals from the temperature sensor 314. The processor 312, is further configured to process the signals according to pre-programmed instructions, and control the position of the switch 304. Thus, in this embodiment, the control module 126, is pre-programmed to place the switch 304, in an open or closed position at predetermined temperatures.

The temperature sensor 314, is connected to the processor 312, as to provide the processor 312, with electrical signals corresponding to the ambient air temperature. Any temperature sensor 314, capable of generating an electric output 306, signal may be compatible with the control module 126, of FIG. 17. Like the processor 312, the temperature sensor 314, is connected to the input 302, of the control module 126, so that it receives a constant supply of power from the power source PS, regardless of whether the switch 304, is placed in an open or closed position.

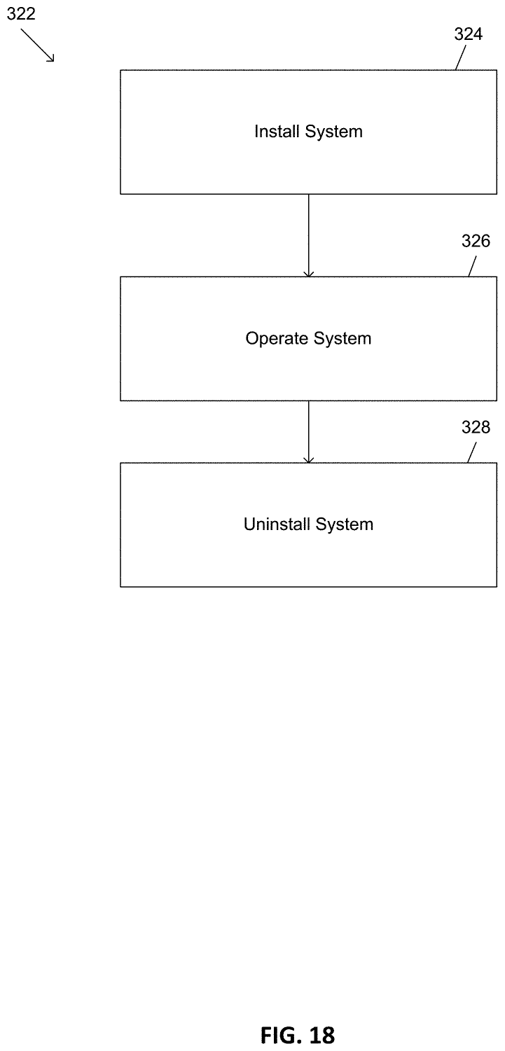

FIG. 18 is a flowchart of an example method 322, of using the heating system 100, of FIG. 1. The example method 322, includes operations 324, 326, and 328.

In one embodiment, the method 322, takes place over a span of several seasons. In this embodiment, the operation 324, is performed to install the heating system 100, in the fall. The operation 326, is then performed to operate the heating system 100, during the winter. Next, the operation 328, is performed to uninstall the heating system 100, in the spring.

In other embodiments, the method 322, takes place over a span of several years. In this embodiment, after the operation 324, is performed to install the heating system 100, the operation 326, is performed repeatedly to operate the heating system 100, during cold weather seasons while the heating system 100, is in place on the building. Finally, the operation 328, is performed to uninstall the heating system 100, years later.

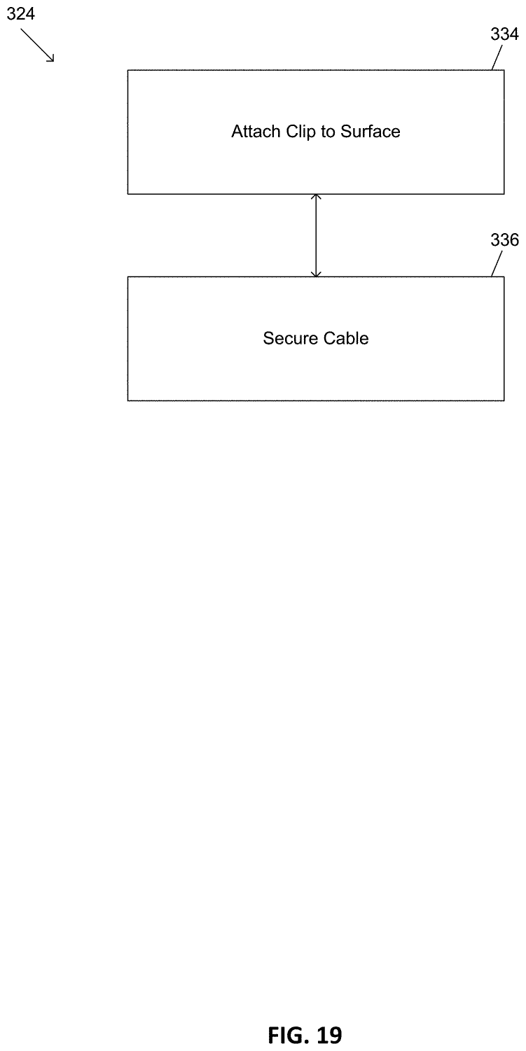

During the operation 324, the heating system 100, is attached to the building so that the clips 106, 108, secure the heating cable 102, thereto. The operation 324, is described in further detail with reference to FIGS. 19-21.

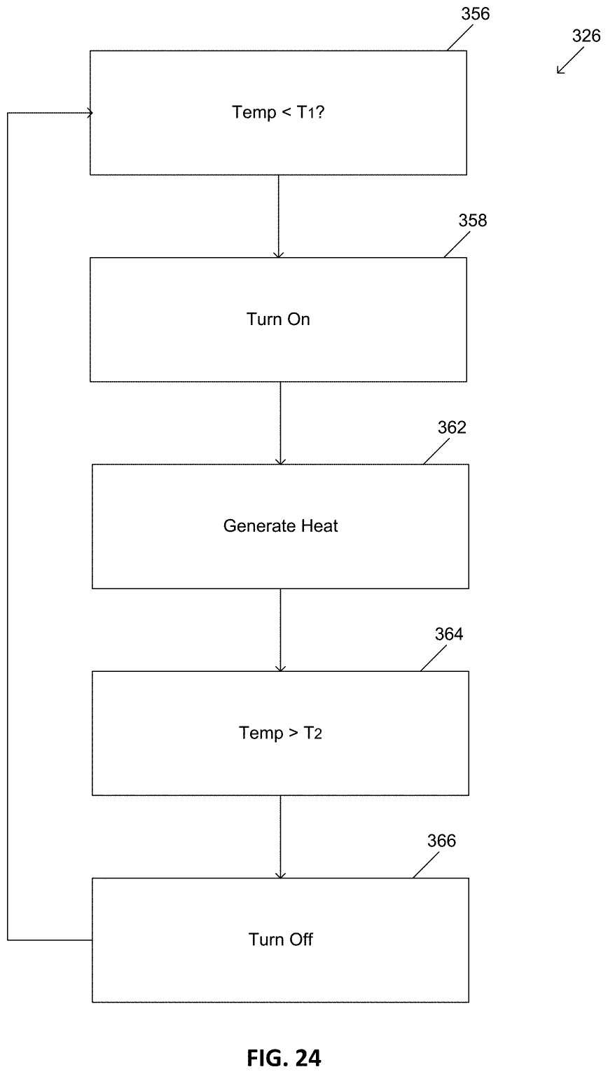

During the operation 326, the heating system 100, either remains inactive on the building or generates heat to prevent the buildup of ice dams. The operation 326, is described in further detail with reference to FIG. 24.

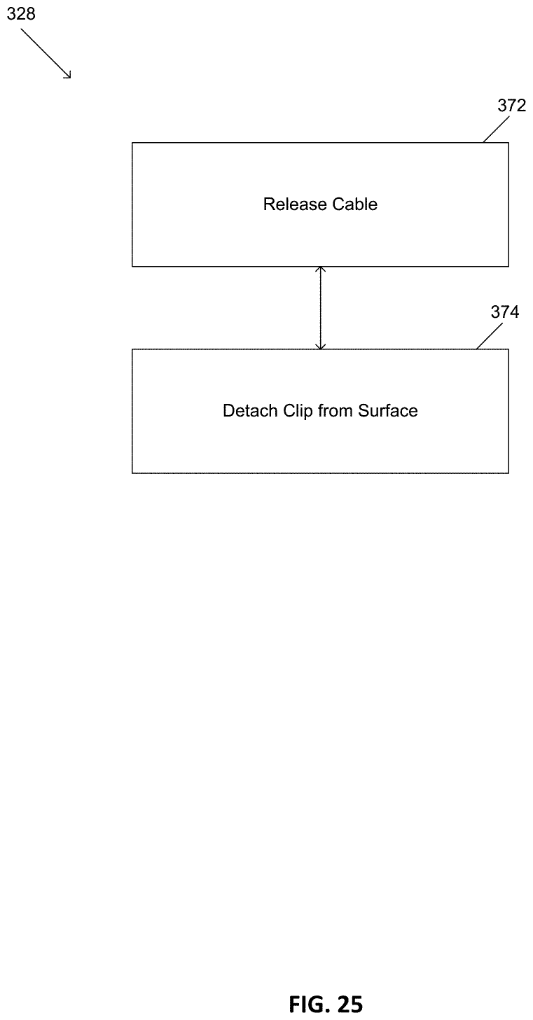

During the operation 328, the heating system 100, is removed from the building. The operation 328, is described in further detail with reference to FIG. 25-27.

FIG. 19 is a flowchart of an example method 324, of installing the heating system 100. The method 324, is an example of the operation 324, of FIG. 18. The example method 324, includes operations 334, and 336.

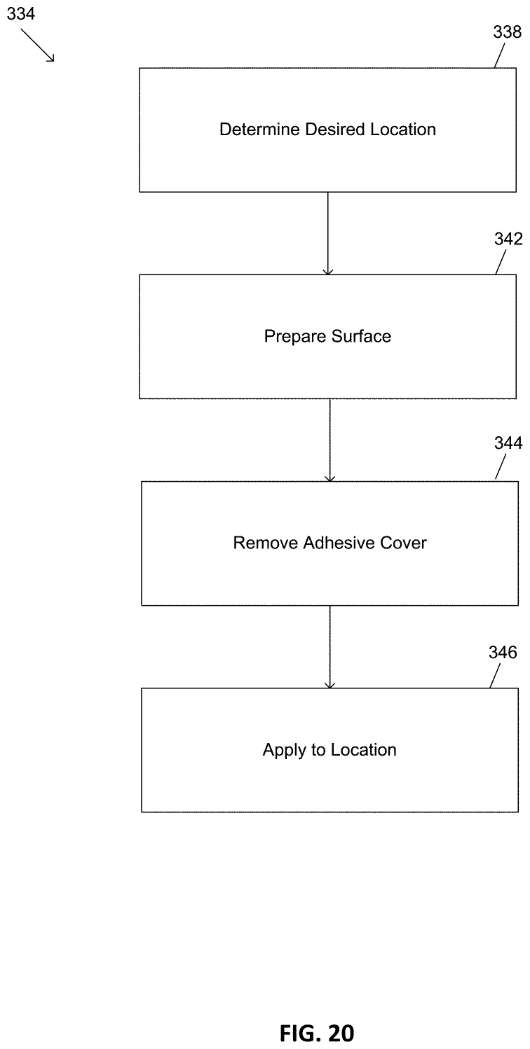

Depending on the type of other clip 108, the operation 334, performed to attach the clip 108, to the surface, will vary and may include, for example, nailing or sliding the clip 108, onto a roof shingle. The operation 334, as performed using an adhesive clip 106, is described in further detail with reference to FIG. 20.

The operation 336, consists of securing the heating cable 102, within the cable cradle 204, of the adhesive clips 106, or other clips 108. The operation 336, is described in further detail with reference to FIG. 21.

In a first embodiment, the operation 334, is performed prior to the operation 336. In this embodiment, the adhesive clips 106, and other clips 108, are first attached to the building in areas where heating cable 102, is intended to be routed.

In another embodiment, the operation 336, is performed before the operation 334, so that the adhesive clips 106, and other clips 108, are attached to the building with the heating cable 102, already secured therein.

In a further embodiment, the operation 334, and operation 336, are repeated in series along the length of the heating cable 102. In this embodiment, the operation 334, and operation 336, are performed, in either order, with one or more clips 106, 108, at one location on the length of the heating cable 102. After completing both operations 334, 336, the method 324, is then repeated with the next one or more clips 106, 108, at a next location along the length of the heating cable 102.

FIG. 20 is a flowchart of an example method 334, of attaching the adhesive clip 106, to the surface. The method 334, is an example of the operation 334, shown in FIG. 19. The method 334, includes operations 338, 342, 344, and 346.

The operation 338, includes examining a surface for a suitable location for adhesive clip 106, application. In some embodiments, the operation 338, includes examining surfaces on the building and building features to find a location with a smooth flat surface large enough for the base portion 202, of the adhesive clip 106, to lie flat upon. The surface may be either porous or non-porous. Surfaces suitable for adhesive clip 106, application include, for example, acrylic glass, metallic, concrete, epoxy resin, plastic, carbon, plaster, resins, stone, rubber, polyethylene, glass, or wood. In some embodiments, maximum adhesion is achieved when the adhesive clip is mounted to clean, smooth, non-porous surfaces such as metal, rubber, PVC, and glass.

The operation 342, is performed to prepare the surface for adhesive clip 106, application and depends largely on the type and condition of the surface selected in operation 338. The operation 342, includes preparing a surface for application of the adhesive clip 106. Surface preparation may include, for example, cleaning the surface, drying the surface, chemically treating the surface, degreasing the surface, mechanically abrading the surface, sanding the surface, brushing the surface, and rinsing the surface. In some cases, the selected surface may not require any surface preparation and the operation 342, may be omitted.

Prior to application, and if an adhesive cover 212, is included on the base portion 202, of the adhesive clip 106, operation 344, is performed. The operation 344, includes removing the adhesive cover 212, from the adhesive portion 208, of the adhesive clip 106. Thus, upon performing operation 344, the adhesive portion 208, is rendered exposed and able to be attached to a surface. In this embodiment, the adhesive cover 212, is peeled off of the adhesive portion 208, and discarded. In some embodiments, the adhesive cover 212, may be removed prior to operations 338, or 342.

Lastly, operation 346, is performed. During operation 346, the adhesive clip 106, is applied to the surface by placing the adhesive clip 106, on a surface and forming an adhesive seal between the adhesive portion 208, and the surface. In some embodiments, the operation 346, includes gently placing the base portion 202, of the adhesive clip 106, upon the selected surface in such a way that minimal air bubbles are formed within the adhesive seal. After the adhesive clip 106, is placed on the surface, pressure is applied to further strengthen the adhesive seal between the adhesive portion 208, and the surface. In some embodiments, pressure is applied for a period of 10-15 seconds.

FIG. 21 is a flowchart depiction of an example method 336, of securing the heating cable 102, within the adhesive clip 106. The method 336, is an example of the operation 336, of FIG. 19. The method 336, includes operations 348, 352, and 354.

The method 336, is performed to secure the heating cable 102, to the adhesive clip 106.

The operation 348, includes placing a heating cable 102, within the cable cradle 204. In some embodiments, the heating cable 102, is placed against the rearmost edge of the interior of the cable cradle 204, and is oriented so that a major axis of an elliptical heating cable 102, cross section is generally parallel to the central portion 218a, of the first cable guide 218, of the cable cradle 204. In some embodiments, when placing the heating cable 102, in the cable cradle 204, the adjacent lengths of the heating cable 102, are examined to ensure that the heating cable 102, is not twisted prior to securing within the cable cradle 204. If twists in the heating cable 102, length are detected, the heating cable 102, may be reconfigured as to remove the twists from the length of the heating cable 102.

Once the heating cable 102, is placed within the cable cradle 204, the operation 352, is performed to bend the cable cradle 204, by moving the second cable guide 222, downwards around the circumference of the heating cable 102, by bending the second neck 216, of the cable cradle 204. Thus, the front edge of the second cable guide 222, is moved to a position generally below the upper edge of the first cable guide 218.

The method 336, is generally completed upon performing operation 354. Operation 354, involves folding the cable cradle 204, around the heating cable 102, by folding the second cable guide 222, of the cable cradle 204, over the front edge of the heating cable 102. In some embodiments, the central portion 222a, of the second cable cradle 204, is substantially parallel with the central portion 218a, of the first cable cradle 204. Thus, the cable cradle 204, is folded over itself around the heating cable 102, at the second neck 216, of the cable cradle 204.

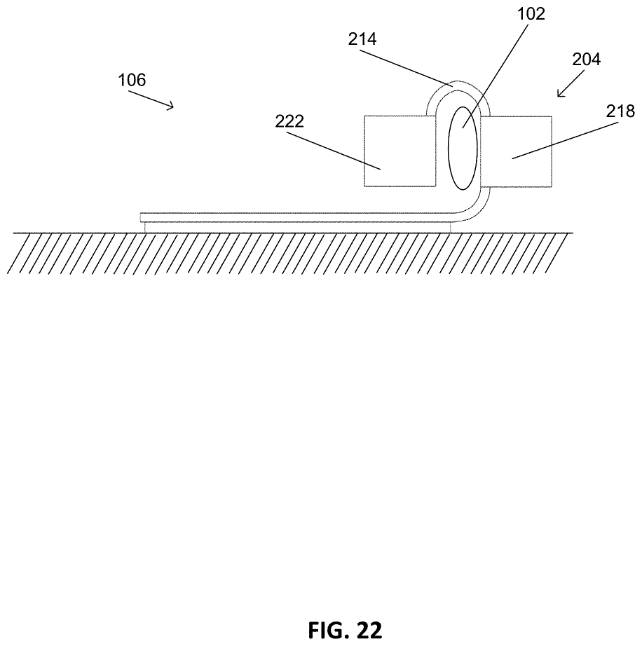

FIG. 22 is a side view of an example heating cable 102, cross section secured within the cable cradle 204, after the adhesive clip 106, is attached to a surface.

In this example, the heating cable 102, is positioned within the fold in the cable cradle 204, so that the major axis of the heating cable 102, cross section is oriented in a substantially vertical direction and parallel with the central portions 218a, 222a (shown in FIG. 12), of the first and second cable guides 218, 222. Thus, the fold in the cable cradle 204, at the second neck 216, is located at a position directly above the vertex of the elliptical cross section of the heating cable 102. The cable cradle 204, of FIG. 22 is further configured so that the first and second cable guides 218, 222, are positioned on the front and rear sides of the heating cable 102. Thus, the cable guides 218, 222, are positioned as to secure and guide the heating cable 102, after the heating cable 102, is installed in the adhesive clip 106.

Further, in this example, an adhesive seal is formed between the adhesive portion 208, of the adhesive clip 106, and the surface. The adhesive cover 212, shown in FIG. 7 is no longer visible, as it is discarded prior to applying the adhesive clip 106, to the surface. In this example, the surface is both flat and large enough so that the entire base portion 202, of the adhesive clip 106, is able to lie flat upon it. Thus, the entirety of the adhesive portion 208, is placed in contact with the surface as to achieve a maximum adhesive seal area.

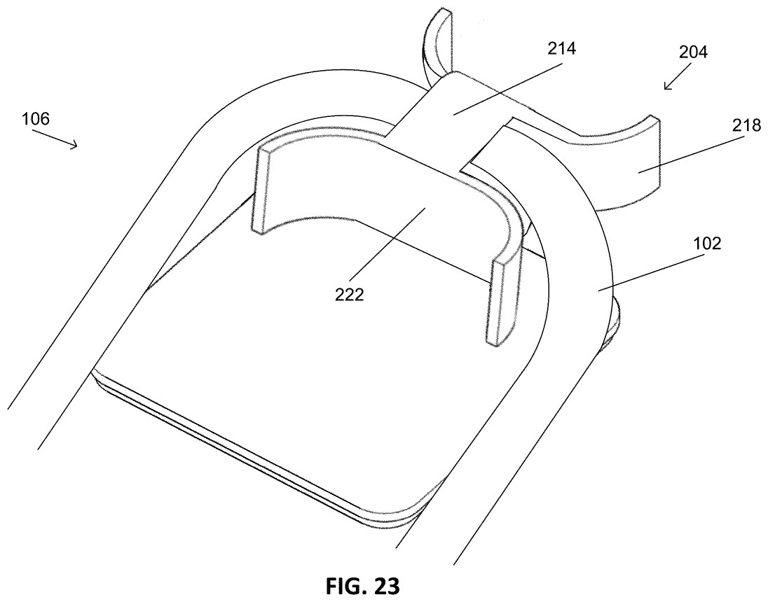

FIG. 23 is a perspective view of an example heating cable 102, secured within a cable cradle 204, of an example adhesive clip 106.

In this embodiment, the heating cable 102, is depicted and is secured within the cable cradle 204, of the adhesive clip 106. Once the heating cable 102, is secured and the cable cradle 204, is folded over the heating cable 102, the cable guides 218, 222, help control the position of the heating cable 102. Specifically, the wings 218b, 218c, 222b, 222c, of the cable guides 218, 222, extend out to provide a smooth curved surface to prevent the heating cable 102, from bending along and contacting what might otherwise be a sharp edge of the cable cradle 204. Thus, damage to the overjacket and other portions of the heating cable 102, which might be caused by contacting such a sharp edge can be avoided.

Further, the cable guides 218, 222, also serve to limit the bending radius of the heating cable 102, and prevent kinks from occurring. By extending outwardly in the left and right directions, the wings 218b, 218c, 222b, 222c, provide a wider surface for the heating cable 102, to bend around. Thus, as the wings 218b, 218c, 222b, 222c, of the cable cradle 204, curve and extend further outwardly, the bending radius of the heating cable 102, is increased. In some embodiments extreme bends in the heating cable 102 may cause the heating cable 102, to weaken or become damaged. Thus, limiting and increasing the bending radius of the heating cable 102, with the cable guides 218, 222, may be desirable.

FIG. 24 is a flowchart of an example method 326, of operating the heating system 100. The method 326, is an example of the operation 326, shown in FIG. 18. The example method 326, includes operations 356, 358, 360, 362, 364, and 366.

In some embodiments, the method 326, of operating the heating system 100, is performed using the control module 126. This embodiment may be desirable, as it allows for reduced power consumption by the heating system 100, during temperature conditions in which ice dams are unlikely to form, thereby making it unnecessary for the heating system 100, to generate heat.

In some embodiments, the operation 356, is performed by detecting a temperature below a threshold. In some embodiments the threshold is a first threshold value. The first threshold value is pre-set and typically corresponds to the temperature at which ice dams may begin to form. The first threshold value may be, for example, 35° F.

If a temperature below the first threshold value is detected, the system is configured to receive a signal to perform operation 358, which includes supplying the heating cable 102, with power, thereby switching the heating cable 102, to an “on” state.

Once the heating cable 102, is supplied with power, the operation 362, is performed to generate heat. Thus, the heating cable 102, heats up and is capable of melting and preventing nearby ice dams. Further description of how the heating cable 102, generates heat is provided in conjunction with FIGS. 4 and 5 of the present application.

In some embodiments, the operation 364, is performed to detect a temperature above a threshold and is further configured to use a second threshold value that that is different than the first threshold value used in operation 356. The second threshold value is pre-set and typically corresponds to the temperature greater than at which ice dams may begin to melt. The second threshold value may be, for example, 40° F. In some embodiments, the first threshold value and second threshold value may be equal.

If a temperature above the second threshold value is detected, operation 366, is performed to so that the system is configured to receives a signal to cease supplying the heating cable 102, with power, thereby switching the heating cable 102, to an “off” state. When the power supply to the heating cable 102, is ceased, the heating cable 102, stops generating heat.

After the operation 366, is performed to switch the heating cable 102 off, the process repeats and the system continues to perform operation 356, to detect a temperature below a first threshold value.

FIG. 25 is a flowchart of an example method 328, of uninstalling the heating system 100. The method 328, is an example of the operation 328, shown in FIG. 18. The example method 328, includes operations 372, and 374.

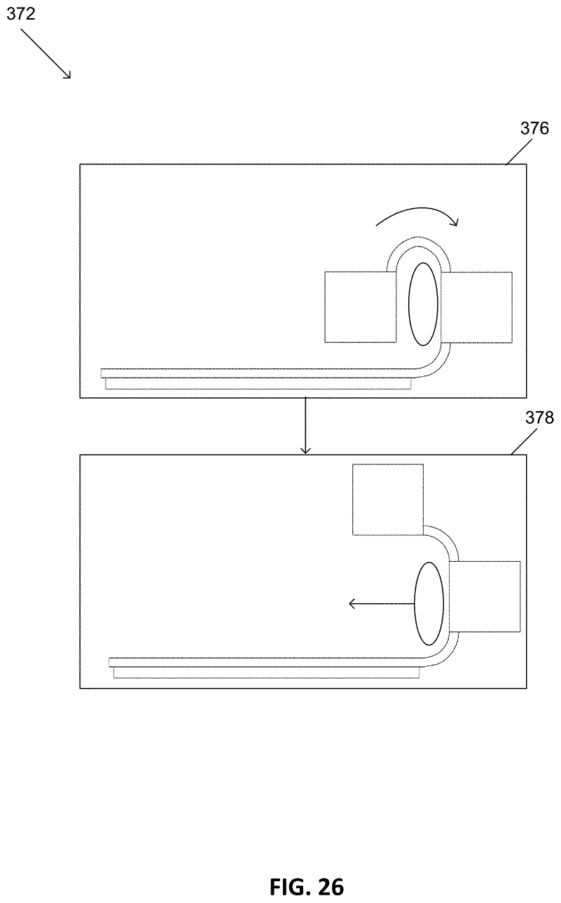

The operation 372, is performed to release the heating cable 102, and consists of releasing the heating cable 102, from within the cable cradle 204, of the adhesive clips 106, or other clips 108. The operation 372, is described in further detail with reference to FIG. 26.

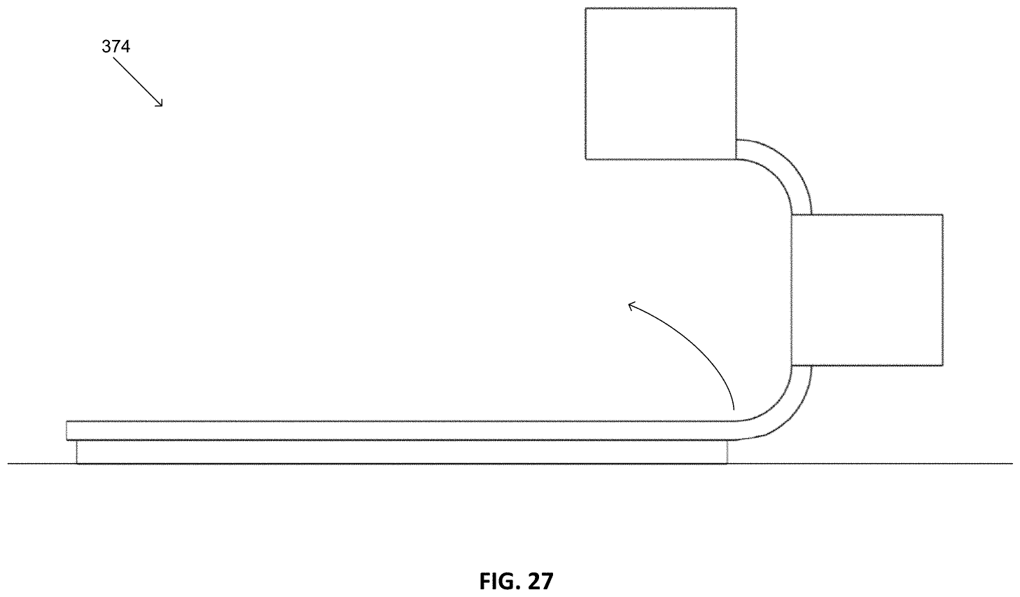

The operation 374, is performed to detach a clip 106, 108, from the surface. Depending on the type of other clip 108, the operation 374, may include, for example, removing nail from, or sliding the clip 108, off of a roof shingle. The operation 374, as it is performed with an adhesive clip 106, is described in further detail with reference to FIG. 27.

In a first embodiment, the operation 372, is performed to release the heating cable 102, before the operation 374, is performed to detach the adhesive clips 106, from surface, so that the adhesive clips 106, are attached to the building while the heating cable 102, is released therefrom. After the heating cable 102, is removed, the adhesive clips 106, are then removed from the building.

In another embodiment, the operation 374, is performed to detach the clips 106, 108, from the surface before the operation 372, is performed to release the heating cable 102. In this embodiment, the adhesive clips 106, and other clips 108, are first removed from the building with the heating cable 102, still secured thereto, at which point, the heating cable 102, is then released from the clips 106, 108.

In a further embodiment, the operation 374, is performed to detach less than all of the clips 106, 108, from surface, and the operation 372, is performed to detach less than the entire heating cable 102. Thus, operations 372, and 374, are repeated in series along the length of the heating cable 102. In this embodiment, the operations 372, and 374, are performed in either order, with one or more adhesive clips 106, at one or more locations on the length of the heating cable 102. After completing both operations 372, 374, the method 328, is then repeated with the next one or more adhesive clips 106, at a next one or more locations along the length of the heating cable 102.

FIG. 26 is a flowchart side view depiction of an example method 372, of releasing the heating cable 102, from a clip 106, 108. The method 372, is an example of the operation 328, of FIG. 25. The example method 372, includes operations 376, and 378.

The operation 372, includes releasing a heating cable 102, from within the cable cradle 204.

In some embodiments, the operation 376, includes bending the cable cradle 204, on the fold of the second neck 216, as to bring the second cable guide 222, into a position where it is no longer securing the heating cable 102, in place. Thus, the second cable guide 222, is removed from its position in front of the heating cable 102. In some embodiments, the second cable guide 222, may be reoriented so that the central portion 222a of the second cable guide 222, is substantially parallel with the base plate 206, of the base portion 202.

The operation 378, includes removing the heating cable 102, from the cable cradle 204. The heating cable 102, is removed through the space created between the edge of the second cable guide 222, and the base plate 206.

FIG. 27 is a side view of an example method 374, of detaching the adhesive clip 106, from the surface. The method 374, is an example of the operation 374, shown in FIG. 25. The method 374, includes peeling the base plate 206, off of the surface.

In some embodiments, the method 374, is performed by pulling on the cable cradle 204, in an upward direction as to break the seal between the adhesive portion 208, and the surface. In other embodiments, the method 374, is performed by inserting a wedge between the base plate 206, and the surface. After the adhesive clip 106, is removed from the surface, surface cleaning may be required to remove any adhesive residue remaining on the surface.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A clip comprising:
a base portion, wherein the base portion is substantially flat and has a top and bottom side, wherein an adhesive material is arranged at the bottom side; and
a cable cradle, configured to receive a cable, and protruding outwardly from the base portion, wherein the cable cradle is configured to be bendable by a user to secure the cable therein.

2. The clip of claim 2, wherein the cable cradle is configured to receive a heating cable.

3. The clip of claim 3, wherein the cable cradle includes cable guides configured to limit the bending radius of the cable.

4. The clip of claim 1, wherein the cable cradle extends upwardly from the base portion.

5. The clip of claim 4, wherein the cable cradle bends to extend in a plane substantially parallel to the plane of the base portion.

6. The clip of claim 1, wherein the adhesive material includes a double sided adhesive layer.

7. The clip of claim 1, wherein the base portion is substantially rectangular.

8. A heating system for melting ice dams on buildings comprising:
at least one heating cable; and
at least one clip comprising:
a substantially flat base portion, wherein an adhesive material is arranged at the bottom side; and
a cable cradle, wherein the cable cradle is configured to receive the heating cable.

9. The heating system of claim 8, wherein the system includes the clip used in conjunction with other types of cable supporting clips.

10. The heating system of claim 8, wherein the system further includes a control module configured to supply power the heating cable in response to environmental conditions.

11. The heating system of claim 10, wherein the environmental conditions include temperature, precipitation, cloud cover, or humidity.

12. The heating system of claim 8, wherein the adhesive material includes a double sided tape.

13. A method of installing a heating system for melting ice dams on buildings comprising:
attaching at least one adhesive clip to a surface on a building; and
securing at least one heating cable to the building with the adhesive clip.

14. The method of claim 13, wherein at least one other type of clip is attached to the surface of the building and used in combination with the at least one adhesive clip to secure the at least one heating cable to the building.

15. The method of claim 13, wherein the at least one adhesive clip is attached to a flat surface on the building.

16. The method of claim 13, wherein the at least one adhesive clip is secured to other structures mounted on the surface of the building.

17. The method of claim 13, wherein the at least one heating cable is secured to the at least one adhesive clip before attaching the at least one adhesive clip to the building.
